(19) United States
(12) Patent Application Publication
(10) Pub. No.: US 2006/0101240 A1
(43) Pub. Date: May 11, 2006

(54) Digital signal processing circuit and digital signal processing method

(75) Inventor: Yoshihisa Arai, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/228,212

(22) Filed: Sep. 19, 2005

(30) Foreign Application Priority Data
Sep. 22, 2004 (JP) 2004-275510

(51) Int. Cl. G06F 9/40

(52) U.S. Cl. 712/209

(57) ABSTRACT

According to an aspect of the present invention, there is provided with a digital signal processing circuit, including: an instruction memory which outputs an instruction code containing at least one instruction and a selection code; an extended-instruction storage which stores extended instructions; a selector which selects, from the extended-instruction storage, an extended instruction represented by the selection code contained in the instruction code outputted from the instruction memory; and a decoder which interprets the instruction contained in the instruction code and the extended instruction selected by the selector and generates a control signal for executing the instruction and the extended instruction.

### CROSS REFERENCE TO RELATED APPLICATIONS

This application is based upon and claims the benefit of priority from the prior Japanese Patent Application No. 2004-275510, filed on Sep. 22, 2004, the entire contents of which are incorporated herein by reference.

### BACKGROUND OF THE INVENTION

1. Field of the Invention

The present invention relates to a digital signal processing circuit and digital signal processing method.

2. Related Art

In processors such as CPUs or DSPs, long instruction code is functionally desirable because a large number of instructions can be included, increasing the degree of freedom for parallel instruction execution. On the other hand, short instruction code is desirable for large-scale integration in terms of chip areas and power consumption because smaller memory areas are required of a RAM or ROM in order to store instruction codes.

For an actual processor, an appropriate instruction code length is sought to strike a balance. However, even if a balanced instruction code length is determined, some instruction codes can contain only a single instruction (e.g., when a classification code to be contained in the instruction code is too long), making parallel instruction execution impossible. That is, some instruction codes use only part of hardware circuits. In that case, no parallel operation is performed and hardware resources are not used efficiently.

### SUMMARY OF THE INVENTION

According to an aspect of the present invention, there is provided with a digital signal processing circuit, comprising: an instruction memory which outputs an instruction code containing at least one instruction and a selection code; an extended-instruction storage which stores extended instructions; a selector which selects, from the extended-instruction storage, an extended instruction represented by the selection code contained in the instruction code outputted from the instruction memory; and a decoder which interprets the instruction contained in the instruction code and the extended instruction selected by the selector and generates a control signal for executing the instruction and the extended instruction.

According to an aspect of the present invention, there is provided with a digital signal processing method, comprising: outputting an instruction code, containing at least one-instruction and a selection code from an instruction memory; reading out, from an extended-instruction storage, an extended instruction represented by the selection code contained in the instruction code outputted; and interpreting the instruction contained in the instruction code and the extended instruction read out and generating a control signal for executing the instruction and the extended instruction.

### BRIEF DESCRIPTION OF THE DRAWINGS

FIG. 1 is a block diagram showing a configuration of a digital signal processing circuit according to an embodiment of the present invention;

FIG. 2 is a flowchart illustrating operation of the digital signal processing circuit in FIG. 1;

FIG. 3 is a diagram showing a configuration of a digital signal processing circuit which takes instructions to be registered out of a data memory; and

FIG. 4 is a diagram showing an example of operation code assignments.

### DETAILED DESCRIPTION OF THE INVENTION

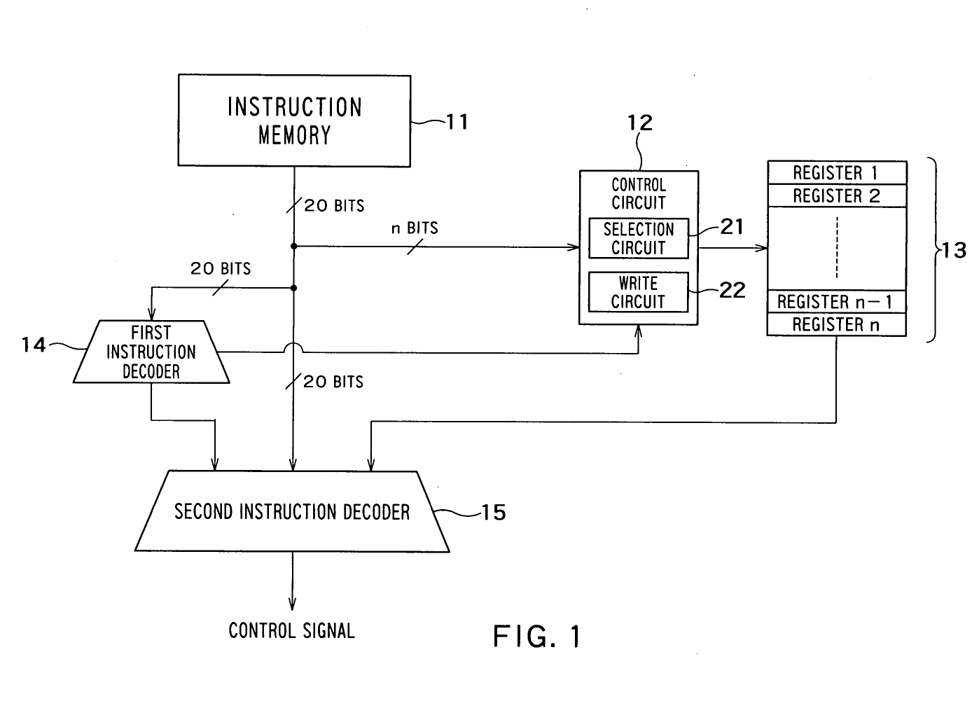

FIG. 1 is a block diagram showing a configuration of a digital signal processing circuit according to an embodiment of the present invention.

The digital signal processing circuit has an instruction memory 11, control circuit 12, register group 13, first instruction decoder 14, and second instruction decoder 15.

The instruction memory 11 stores an instruction code to be executed and outputs an instruction code to be executed next according to a program counter (not shown).

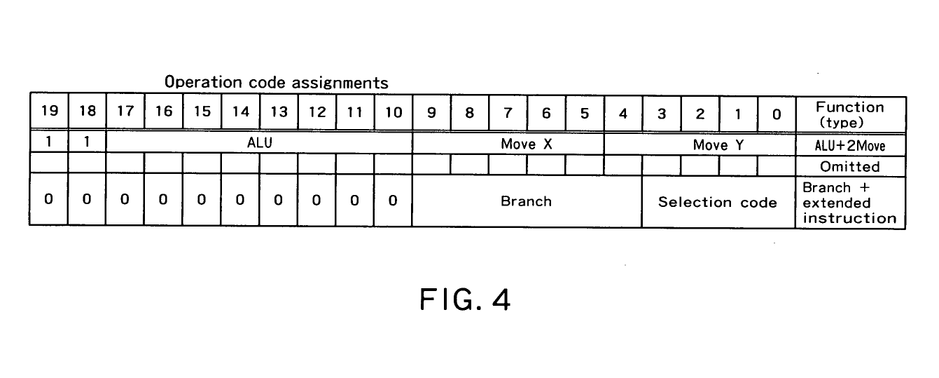

FIG. 4 shows an example of operation code assignments.

Twenty (20) bits from the 0th to 19th digits in each row make up one instruction code.

The instruction code in the first row simultaneously executes an arithmetic logic unit (ALU) instruction and two data transfer instructions (Move X and Move Y).

More specifically, the ALU instruction in the 10th to 17th digits specifies arithmetic and logic operations (e.g., addition, subtraction, logical addition (OR), and/or logical product (AND)).

For example, if the ALU instruction is “00000000” (the leftmost digit is the 17th digit and the rightmost digit is the 10th digit), it means adding the value of a register x0 to the value of a register y0 and assigning the sum in a register z0. Specifically, “000” in the 15th to 17th digits specifies addition, “00” in the 13th to 14th digits specifies the register x0, “00” in the 11th to 12th digits specifies the register y0, and “0” in the 10th digit specifies the register z0.

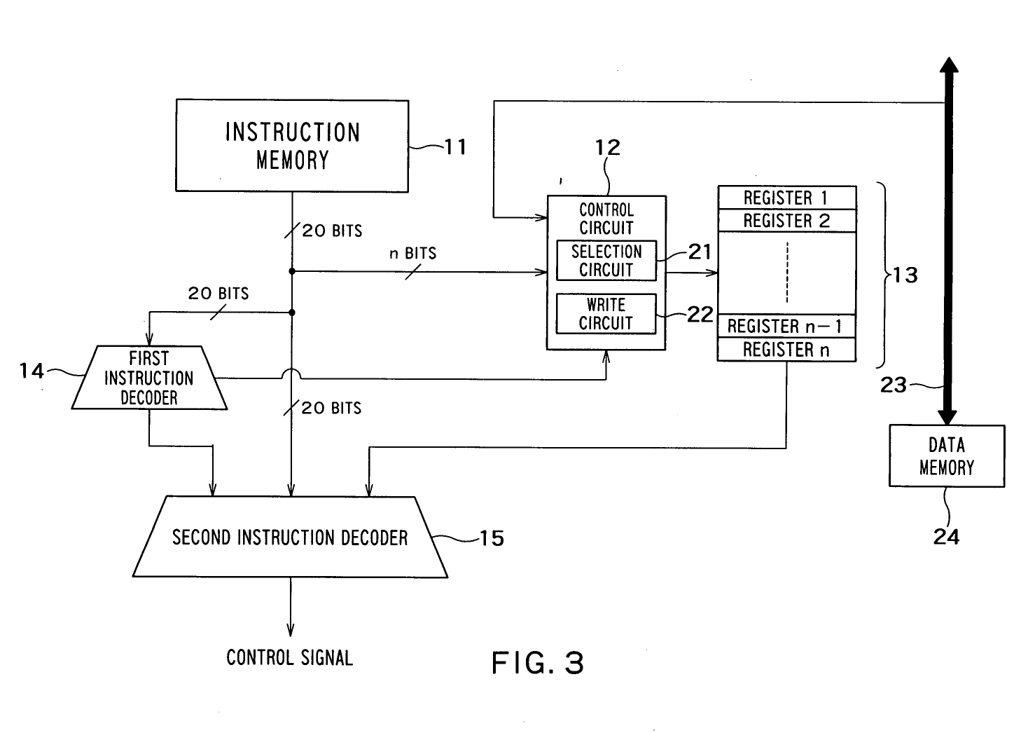

The Move X instruction in the 5th to 9th digits specifies data transfer between registers or from a data memory (see FIG. 3) to a register. For example, if the Move X instruction is “00001” (the leftmost digit is the 9th digit and the rightmost digit is the 5th digit), it means transferring the value of a register r0 to a register x0 (x0=r0). On the other hand, if the Move X instruction is “01000,” it means transferring the value stored at a data memory address pointed to by a pointer ax1 to the register x0 and incrementing the value of the pointer ax1 by 1 (x0=*(ax1++)).

The Move Y instruction in the 0th to 4th digits specifies data transfer between registers or from a data memory (see FIG. 3) to a register. For example, if the Move Y instruction is “00001” (the leftmost digit is the 4th digit and the rightmost digit is the 0th digit), it means transferring the value of a register r1 to a register y0 (y0=r1). On the other hand, if the Move Y instruction is “01000,” it means transferring the value stored at a data memory address pointed to by a pointer ay1 to the register y0 and incrementing the value of the pointer ay1 by 1 (y0=*(ay1++)).

Besides, “11” in the 18th to 19th digits is a classification code which indicates the type of the instruction code. Specifically, this classification code indicates that the instruction code contains an arithmetic logic unit instruction and two data transfer instructions.

The instruction code in the bottom row of FIG. 4 executes a branch instruction and an extended instruction selected based on a selection code.

More specifically, the Branch instruction in the 4th to 9th digits specifies branching (e.g., “return” or “goto”). For example, if the Branch instruction is “000000,” it means returning (setting a program counter) to an address in the instruction memory 11, indicated by a return value saved in a stack register.

The selection code in the 0th to 3rd digits is used to select a register represented by the selection code from the register group 13 and execute an instruction (extended instruction) contained in the selected register, as described later.

Besides, “00 . . . 00” in the 10th to 19th digits is a classification code which indicates the type of the instruction code. Specifically, this classification code indicates that the instruction code contains a branch instruction and selection code.

In FIG. 1, the first instruction decoder 14 receives the instruction code outputted from the instruction memory 11 and identifies the type of the instruction code based on the received instruction code.

More specifically, the first instruction decoder 14 identifies the type of the instruction code based on the classification code contained in the instruction code.

For example, if the received instruction code contains ten consecutive zeros “0000000000” (classification code) from the 19th to lower order digits, it is determined that the type of the instruction code is “branch+extended instruction” (see FIG. 4). That is, the first instruction decoder 14 determines that the instruction code contains a branch instruction in the 4th to 9th digits, and a selection code in the 0th to 3rd digits. Furthermore, based on the classification code, the first instruction decoder 14 also identifies the type of the extended instruction represented by the selection code (e.g., ALU instruction, Move X instruction+Move Y instruction, Move X instruction, Move Y instruction, immediate instruction, multiplication instruction, or the like).

The first instruction decoder 14 inputs the results of identification (the type of the instruction code and type of the extended instruction) to the second instruction decoder. Also, based on the classification code, the first instruction decoder 14 generates a selection signal which indicates bit locations where the selection code is located, and outputs the selection signal to the control circuit 12.

The control circuit 12 has a selection circuit 21 and a write circuit 22. It receives all or part of the bits of the instruction code (e.g., the low-order ten bits or the like of a 20-bit long instruction code) outputted from the instruction memory 11.

Based on all or part of the bits of the instruction code received from the instruction memory 11 and the selection signal received from the first instruction decoder 14, the selection circuit 21 detects the bits at locations indicated by the selection signal, from all or part of the bits of the instruction code and outputs the detected bits to the register group 13. For example, if the selection signal indicates the low-order four bits (0th to 3rd digits) (see the bottom row of FIG. 4), the first instruction decoder 14 outputs these four bits by detecting them from all or part of the bits of the instruction code.

The register group 13 has a plurality of registers 1 to n each of which stores an extended instruction(s) (e.g., ALU instruction, Move X instruction+Move Y instruction, Move X instruction, Move Y instruction, immediate instruction, multiplication instruction, or the like). In this example, the register group 13 has 16 registers 1 to 16. The register group 13 selects a register represented by any bits inputted from the control circuit 12. For example, if bits “0000” are inputted, the register 1 is selected; if bits “0001” are inputted, the register 2 is selected; . . . ; and if bits “1111” are inputted, the register 16 is selected. The register group 13 outputs the extended instruction which is stored in the register thus selected, to the second instruction decoder 15.

The extended instruction is registered in the register of the register group 13 by the write circuit 22 of the control circuit 12. The write circuit 22 registers the extended instruction in the register group 13, for example, as follows.

First, a field of a decision bit is added to the instruction code, for use to determine whether to register an instruction. If the decision bit is on, the instruction contained in the instruction code is registered as an extended instruction in the register, and if the decision bit is off, the instruction is not registered. More specifically, when the first instruction decoder 14 (or the second instruction decoder 15) detects that the decision bit is on, the first instruction decoder 14 outputs an indicator signal (which contains, for example, bit locations of the given instruction in the instruction code and an identifier of a destination register, where the bit locations and destination registers are determined by the classification code contained in the instruction) to the write circuit 22, indicating the write circuit 22 to register the instruction. The write circuit 22 detects the bits at the locations indicated by the indicator signal from all or part of the bits of the instruction code received from the instruction memory 11 and registers them as an extended instruction in the specified destination register.

Second, a dedicated instruction code is prepared for use to register the extended instruction in the register. The extended instruction is registered according to the dedicated instruction code. More specifically, when the dedicated instruction code is inputted, the first instruction decoder 14 (or the second instruction decoder 15) outputs an indicator signal (which contains, for example, bit locations of the given instruction in the dedicated instruction code and an identifier of a destination register) to the write circuit 22, indicating the write circuit 22 to register the instruction contained in the dedicated instruction code. The write circuit 22 detects the bits at the locations indicated by the indicator signal from all or part of the bits of the dedicated instruction code received from the instruction memory 11 and registers them as an extended instruction in the specified destination register.

Third, a dedicated register is prepared. The extended instruction is registered according to the value of the dedicated register. For example, when the dedicated register is “1”, the first instruction decoder 14 (or the second instruction decoder 15) outputs an indicator signal (which contains, for example, bit locations of the given instruction in the instruction code and an identifier of a destination register, where the bit locations and destination registers are determined by the classification code contained in the instruction) to the write circuit 22, indicating the write circuit 22 to register the instruction. The write circuit 22 detects the bits at the locations indicated by the indicator signal from all or part of the bits of the instruction code received from the instruction memory 11 and registers them as an extended instruction in the specified register.

Referring to FIG. 1, the second instruction decoder 15 receives the instruction code from the instruction memory 11, and results of identification (the type of the instruction code and type of the extended instruction) from the first instruction decoder 14. Also, if the instruction code outputted from the instruction memory 11 contains a selection code, the extended instruction selected by the selection circuit 21 is inputted in the second instruction decoder 15 from the register group 13.

Based on the type of the instruction code received from the first instruction decoder 14, the second instruction decoder 15 identifies the type of the instruction (e.g., ALU instruction, Move X instruction+Move Y instruction, Move X instruction, Move Y instruction, immediate instruction, multiplication instruction, or the like) contained in the instruction code received from the instruction memory 11. Then, based on the result of identification, the second instruction decoder 15 generates and outputs a control signal for use to execute the instruction. Also, based on the type of the extended instruction received from the first instruction decoder 14, the second instruction decoder 15 identifies the type of the extended instruction (e.g., ALU instruction, Move X instruction+Move Y instruction, Move X instruction, Move Y instruction, immediate instruction, multiplication instruction, or the like) received from the register group 13. Then, based on the result of identification, the second instruction decoder 15 generates and outputs a control signal for use to execute the second instruction.

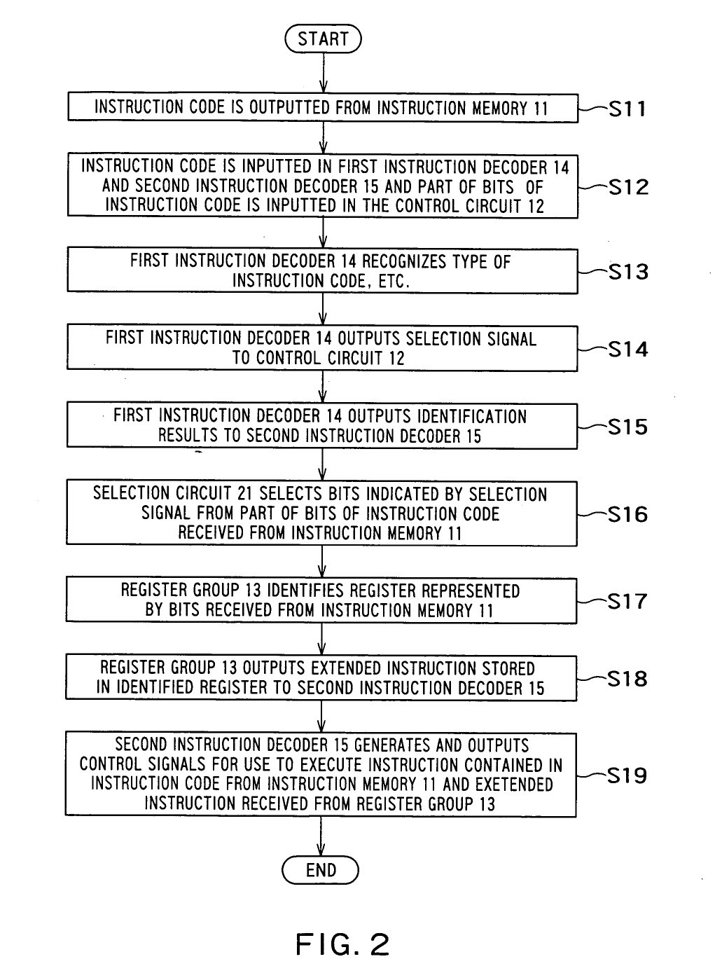

FIG. 2 is a flowchart illustrating operation of the digital signal processing circuit in FIG. 1.

In the following description, execution of an instruction code of the “branch+extended instruction” type shown in the bottom row of FIG. 4 will be taken as an example.

An instruction code of the “branch+extended instruction” type is outputted from the instruction memory 11 according to a program counter (not shown) (S11).

The instruction code outputted from the instruction memory 11 is inputted in the first instruction decoder 14 and second instruction decoder 15. Also, the low-order ten bits (the 0th to 9th digits) of the instruction code outputted from the instruction memory 11 is inputted in the control circuit 12 (S12).

Based on the classification code (the 10th to 19th digits) in the instruction code received from the instruction memory 11, the first instruction decoder 14 identifies the type of the instruction code. Consequently, the first instruction decoder 14 determines that the instruction code is of the “branch+extended instruction” type (S13). That is, the first instruction decoder 14 determines that the instruction code contains a branch instruction in the 4th to 9th digits, and a selection code as the 0th to 3rd bits. Also, the first instruction decoder 14 identifies the type of the extended instruction represented by the selection code based on the classification code.

The first instruction decoder 14 outputs a selection signal to the control circuit 12 to select the bits (selection code) in the 0th to 3rd digits (the low-order four bits) (S14). Also, the first instruction decoder 14 outputs the results of identification (the type of the instruction code and type of the extended instruction) to the second instruction decoder 15 (S15).

Based on the selection signal received from the first instruction decoder 14, the selection circuit 21 of the control circuit 12 selects the bits indicated by the selection signal from part (the low-order ten bits) of the instruction code received from the instruction memory 11 (S16). Since the selection signal indicates the low-order four bits, the selection circuit 21 selects the low-order four bits (the 0th to 3rd digits) from part (the low-order ten bits) of the instruction code received from the instruction memory 11. The selection circuit 21 outputs the selected low-order four bits to the register group 13.

Based on the bits received from the selection circuit 21, the register group 13 identifies the register represented by the received bits (S17).

The register group 13 outputs the extended instruction stored in the identified register to the second instruction decoder 15 (S18). It is assumed here that the Move X and Move Y instructions are outputted to the second instruction decoder 15.

Based on the identification results (the type of the instruction code and type of the extended instruction) received from the first instruction decoder 14, the second instruction decoder 15 identifies the type of the instruction (branch instruction, in this example) contained in the instruction code received from the instruction memory 11 and type of the extended instruction (the Move X and Move Y instructions, in this example) received from the register group 13. Consequently, the second instruction decoder 15 generates and outputs a control signal for use to execute the branch instruction as well as a control signal for use to execute the Move X and Move Y instructions (S19).

Now, effects of this embodiment will be described.

Suppose that the executable code shown below is provided. This executable code has been used by the inventor before the present invention is made.
x0=*ax1++, y0=*ay1++; (A1)
z0=x0+y0, x0=*ax1++, y0=*ay1++; (A2)
z0=z0+x0+y0, x0=*ax1++, y0=*ay1++; (A3)
z0=z0+x0+y0, x0=*ax1++, y0=*ay1++; (A4)
z0=z0+x0+y0; (A5)
*ax0=z0, *ay0=flag; (A6)
if(z0>0) goto label1; (A7)

In the executable code, instruction code A7 executes only a branch instruction.

In contrast, according to this embodiment, bits which represent two instructions “*az0=z0” and “*ay0=flag” in instruction code A6 are pre-registered in a register in the register group. Then, an instruction code such as instruction code B6 below is prepared. The instruction code contains a branch instruction as well as a selection code for selecting the register which stores the two instructions.
x0=*ax1++, y0=*ay1++; (B1)
z0=x0+y0, x0=*ax1++, y0=*ay1++; (B2)
z0=z0+x0+y0, x0=*ax1++, y0=*ay1++; (B3)
z0=z0+x0+y0, x0=*ax1++, y0=*ay1++; (B4)
z0=z0+x0+y0, x0=*ax1++, y0=*ay1++; (B5)
if(z0>0) goto1 label1; (B6)
//execute also*az0=z0 and *ay0=flag

Here, “goto1” in instruction code B6 is a mnemonic which specifies parallel execution of the instruction(s) stored in the first register of the register group and a branch instruction (goto).

This makes it possible to reduce the number of instruction codes by one. Specifically, by the application of this embodiment, an instruction code allows an arbitrary instruction to be executed in parallel with a branch instruction.

As described above, according to this embodiment, a selection code for use to select an extended instruction pre-registered in a register group is stored in available (unoccupied) bit fields of an instruction code, and consequently an instruction contained in the instruction code and the extended instruction selected from the register group based on the selection code are executed simultaneously at a time of execution of the instruction code. This improves the efficiency of instruction execution greatly. That is, this embodiment makes it possible to implement a processor capable of operating many its circuits simultaneously beyond the bounds of instruction code length.

For example, assuming an iteration loop consisting of ten instructions, if the number of instructions in the iteration loop is reduced by one, efficiency is increased by 10% even if one additional instruction is needed to store the instruction (extended instruction) in a register group. The efficiency increases with increases in the iteration count for the loop.

Although in the above example, transfer instructions have been cited as extended instructions executed in parallel with a branch instruction, other instructions such as an immediate instruction which takes up most bits of an instruction code can also be executed in parallel with a branch instruction.

Incidentally, it is conceivable to make more active use of a register group by making each register in the register group store an instruction code. For example, when executing instruction codes repetitively, if the instruction codes stored in the register group are repeatedly read in sequence, it is possible to eliminate the need to read the instruction codes from an instruction memory, thereby reducing power consumption.

In the above description, the extended instructions to be registered in the register group 13 are provided from the instruction memory 11, but the extended instructions to be registered may be provided from a data memory instead of the instruction memory 11.

FIG. 3 shows a configuration of a digital signal processing circuit which takes instructions to be registered out of a data memory.

Here, a data memory 24 and data bus 23 are added to the configuration shown in FIG. 1. An instruction code is provided for reading instructions out of the data memory 24 and registering them in the register group 13. As the instruction code is executed, the instruction(s) stored at locations indicated by the instruction code are inputted in the control circuit 12 from the data memory 24 via the data bus 23. The write circuit 22 of the control circuit 12 writes the inputted instruction(s) in register according to a control signal from the first instruction decoder 14 or second instruction decoder 15.

In this way, if the instructions to be registered in the register group 13 are stored in the data memory 24, the instructions to be registered can be transferred using short bit instructions by pointer operations (e.g., ext_code0=*ax1++; ext_code1=*ax1++;), and thus the instructions to be registered do not need to be included in instruction code itself. That is, there is no need to use instruction code itself to specify the instructions to be registered. This also makes it possible to reuse the instructions to be registered.

What is claimed is:

1. A digital signal processing circuit, comprising:
an instruction memory which outputs an instruction code, containing at least one instruction and a selection code;
an extended-instruction storage which stores extended instructions;
a selector which selects, from the extended-instruction storage, an extended instruction represented by the selection code contained in the instruction code outputted from the instruction memory; and
a decoder which interprets the instruction contained in the instruction code and the extended instruction selected by the selector and generates a control signal for executing the instruction and the extended instruction.

2. The digital signal processing circuit according to claim 1, wherein the extended-instruction storage includes a plurality of registers each of which stores an extended instruction; and the selector selects a register which corresponds to bit values of the selection code.

3. The digital signal processing circuit according to claim 2, wherein each of the registers store at least one of a data transfer instruction for data transfer between registers, a data transfer instruction for data transfer from data memory to register, and an immediate instruction as the extended instruction.

4. The digital signal processing circuit according to claim 3, wherein the instruction memory outputs an instruction code containing a branch instruction as the instruction.

5. The digital signal processing circuit according to claim 1, wherein the instruction code contains a classification code; the decoder identifies the type of the instruction contained in the instruction code and the type of the selected extended instruction based on the classification code contained in the instruction code and interprets the instruction and the extended instruction based on results of the identification.

6. The digital signal processing circuit according to claim 5, wherein:
the decoder includes a first decoder and a second decoder;
the first decoder identifies the types of the instruction and extended instruction based on the classification code; and
the second decoder interprets the instruction and the extended instruction based on results of the identification.

7. The digital signal processing circuit according to claim 1, wherein:
the instruction code contains a classification code;
the decoder generates a selection signal based on the classification code contained in the instruction code and outputs the generated selection signal to the selector; and
bits of the instruction code are inputted in the selector and bits at locations specified by the selection signal are detected as the selection code by the selector from the bits of the instruction code.

8. The digital signal processing circuit according to claim 7, wherein bits of a part of the instruction code are inputted in the selector.

9. The digital signal processing circuit according to claim 1, wherein the extended instruction is longer in bit length than the selection code.

10. The digital signal processing circuit according to claim 1, further comprising a writer which writes the instruction contained in the instruction code into the extended-instruction storage, wherein:
the instruction code has a decision bit field for use to determine whether to register the instruction contained in the instruction code in the extended-instruction storage; and
the writer writes the instruction contained in the instruction code into the extended-instruction storage if a bit that specifies registration is set in the decision bit field.

11. The digital signal processing circuit according to claim 1, further comprising a writer which writes the instruction contained in the instruction code into the extended-instruction storage, wherein:
the instruction code contains a registration instruction; and
the writer writes the instruction contained in the instruction code into the extended-instruction storage based on a control signal generated from the registration instruction by the decoder.

12. The digital signal processing circuit according to claim 1, further comprising a writer which writes the instruction contained in the instruction code into the extended-instruction storage and a dedicated register, wherein
the writer writes the instruction contained in the instruction code into the extended-instruction storage if a bit that specifies registration is set in the dedicated register.

13. The digital signal processing circuit according to claim 1, further comprising a data memory which stores an extended instruction to be registered in the extended-instruction storage,
wherein the instruction code contains a registration instruction which specifies the extended instruction stored in the data memory to be registered in the extended-instruction storage, and
the digital signal processing circuit further comprises a writer which writes the extended instruction into the extended-instruction storage based on a control signal generated from the registration instruction by the decoder.

14. A digital signal processing method, comprising:
outputting an instruction code, containing at least one instruction and a selection code from an instruction memory;
reading out, from an extended-instruction storage, an extended instruction represented by the selection code contained in the instruction code outputted; and
interpreting the instruction contained in the instruction code and the extended instruction read out and generating a control signal for executing the instruction and the extended instruction.
